(19) United States
(12) Patent Application Publication
(10) Pub. No.: US 2020/0205939 A1
(43) Pub. Date: Jul. 2, 2020

(54) DENTAL IMPLANT

(71) Applicant: Rishon Mor Investment Ltd., Tel-Aviv (IL)

(72) Inventors: Amiram VIZANSKI, Herzlia (IL); Aviv VIZNSKI, Herzlia (IL)

(73) Assignee: Rishon Mor Investments Ltd., Tel-Aviv (IL)

(21) Appl. No.: 16/631,465

(22) PCT Filed: Jul. 17, 2018
(86) PCT No.: PCT/IL2018/050787

§ 371 Date: Jan. 16, 2020

(30) Foreign Application Priority Data
Jul. 17, 2017 (GB) 1711483.6

(51) Int. Cl. A61C 8/00

(52) U.S. Cl. CPC A61C 8/0018

(57) ABSTRACT

A dental implant including a first, apical portion for inserting into bone, and a second, top-side portion, starting at a level of bone surface and higher, including a stricture of the dental implant diameter, relative to a diameter of the top-side portion, for at least part of the top-side portion. Related apparatus and methods are also described.

### RELATED APPLICATION

This application claims the benefit of priority of Great Britain Patent Application No. 1711483.6 filed 17 Jul. 2017, the contents of which are incorporated herein by reference in their entirety.

### FIELD AND BACKGROUND OF THE INVENTION

The present invention, in some embodiments thereof, relates to a dental implant and methods of implantation, and, more particularly, but not exclusively, to an improved dental implant and improved methods of implantation.

Additional background art includes:

International Patent Application No. PCT/IL2013/050885 of Amiram Vizanski, having international filing date of 30 Oct. 2013.

The disclosures of all references mentioned above and throughout the present specification, as well as the disclosures of all references mentioned in those references, are hereby incorporated herein by reference.

### SUMMARY OF THE INVENTION

The present invention, in some embodiments thereof, relates to a dental implant and methods of implantation, and, more particularly, but not exclusively, to an improved dental implant and improved methods of implantation.

In some embodiments a dental implant is provided with an improved profile at a vicinity of the gum tissue-to-bone interface.

In some embodiments a method of implanting a dental implant with an improved profile is provided. In some embodiments the implanting is to a specific depth based on the improvement to the dental implant device.

In some embodiments a surface of a surface of a below-bone portion of the dental implant is made different from a surface of an above-bone portion of the dental implant.

In some embodiments a shape of threads of the dental implant is improved.

In some embodiments a drill is designed to produce a hole in bone and remove gum tissue.

According to an aspect of some embodiments of the present invention there is provided a dental implant including a first, apical portion for inserting into bone, and a second, top-side portion, starting at a level of bone surface and higher, including a stricture of the dental implant diameter, relative to a diameter of the top-side portion, for at least part of the top-side portion.

According to some embodiments of the invention, integrally constructed in one piece.

According to some embodiments of the invention, where a width of the stricture is at least equal to a biological width. According to some embodiments of the invention, a width of the stricture is in a range of 0.3 to 2 millimeters.

According to some embodiments of the invention, a width of the second, top-side portion is nowhere wider than a diameter of a top of the first, apical portion. According to some embodiments of the invention, a width of the second, top-side portion is nowhere wider than a diameter of the dental implant at a top of a section of screw threads in the first, apical portion.

According to some embodiments of the invention, a depth of the stricture is in a range of 0.2 to 1 millimeters.

According to some embodiments of the invention, a top surface of the dental implant is at a distance of at least a biological width above a bottom of the stricture. According to some embodiments of the invention, a top surface of the dental implant is at a distance of at least a biological width above a top of the stricture.

According to some embodiments of the invention, a top surface of the dental implant is at a distance of at least a thickness of a prospective patient's gum above a bottom of the stricture.

According to some embodiments of the invention, a top surface of the dental implant is at a distance of at least a thickness of a prospective patient's gum above a top of the stricture.

According to some embodiments of the invention, a first, apical side surface of the stricture is at a different angle than a second, top-side surface of the stricture relative to a direction of a longitudinal axis of the dental implant.

According to some embodiments of the invention, a first, apical side surface of the stricture is at an angle greater than 30 degrees from a direction of a longitudinal axis of the dental implant.

According to some embodiments of the invention, and further including the first portion having a first surface texture and the top-side portion including a second surface texture for at least part of the top-side portion. According to some embodiments of the invention, the first portion includes a rough surface and the top-side portion includes a smooth surface.

According to some embodiments of the invention, a top surface of the dental implant is at a distance of at least a biological width above a demarcation line between the rough surface and the smooth surface.

According to some embodiments of the invention, the top-side portion includes a smooth surface at a roughness N ISO grade number in a range of N1 to N3.

According to some embodiments of the invention, the rough surface extends along the first portion of the dental implant up to a beginning of the stricture.

According to some embodiments of the invention, the rough surface extends along the first portion of the dental implant up to the stricture and on up into at least a portion of the stricture.

According to some embodiments of the invention, the rough surface extends along the first portion of the dental implant up to the stricture and on up into at least a portion of the stricture, leaving at least a biological width of a smooth surface in the stricture.

According to some embodiments of the invention, the rough surface extends along the first portion of the dental implant up to the stricture and into the stricture up to a top of the stricture.

According to an aspect of some embodiments of the present invention there is provided a method of implanting a dental implant including providing a dental implant including a first, apical portion for inserting into bone and a second, top-side portion including a stricture of the dental implant diameter, relative to a diameter of the first portion, for at least part of the top-side portion, and inserting the dental implant to a depth where a bottom of the stricture is at bone level.

According to some embodiments of the invention, the inserting includes inserting the dental implant to a depth where a bottom of the stricture is lower than bone level and a top of the stricture is higher than bone level.

According to an aspect of some embodiments of the present invention there is provided a dental implant including a first, apical portion with a first surface texture for inserting into bone, and a second, top-side portion starting at a level of bone surface and higher, including a second surface texture for at least part of the top-side portion.

According to some embodiments of the invention, the first portion includes a rough surface and the top-side portion includes a smooth surface.

According to some embodiments of the invention, a top surface of the dental implant is at a distance of at least a biological width above a demarcation line between the rough surface and the smooth surface.

According to some embodiments of the invention, and further including a stricture of the dental implant diameter, relative to a diameter of the first portion, for at least part of the top-side portion.

According to some embodiments of the invention, a width of the stricture is at least equal to a biological width.

According to some embodiments of the invention, a first, apical side surface of the stricture is at a different angle than a second, top-side surface of the stricture relative to a direction of a longitudinal axis of the dental implant.

According to some embodiments of the invention, the rough surface extends along the first portion of the dental implant up to a beginning of the stricture.

According to some embodiments of the invention, the rough surface extends along the first portion of the dental implant up to the stricture and on up into at least a portion of the stricture.

According to some embodiments of the invention, the rough surface extends along the first portion of the dental implant up to the stricture and on up to a top of the stricture.

According to an aspect of some embodiments of the present invention there is provided a method of implanting a dental implant including providing a dental implant including a first, apical portion with a rough surface for inserting into bone and a second top-side portion with a smooth surface starting at a level of bone surface and higher, and inserting the dental implant to a depth where a bottom of the second portion is at bone level.

According to an aspect of some embodiments of the present invention there is provided a method of manufacturing a dental implant including manufacturing a dental implant with a first surface texture, and modifying a portion of the dental implant to have a second surface texture different from the first surface texture.

According to some embodiments of the invention, further including roughening a surface of an apical-side portion of the dental implant and preventing a top-side portion of the dental implant from the roughening in order to make the surface of the top-side portion smoother than the surface of the apical portion of the dental implant.

According to some embodiments of the invention, further including polishing a surface of a top-side portion of the dental implant in order to make the surface of the top-side portion smoother than the surface of an apical portion of the dental implant.

According to some embodiments of the invention, and further including making a surface of the top-side portion of the dental implant hydrophobic.

According to some embodiments of the invention, and further including treating a surface of the top-side portion of the dental implant to reduce adherence of gum tissue to the top-side portion of the dental implant.

According to some embodiments of the invention, and further including making a surface of an apical portion of the dental implant hydrophilic.

According to some embodiments of the invention, and further including treating a surface of the apical portion of the dental implant to improve adherence of bone to the apical portion of the dental implant.

According to an aspect of some embodiments of the present invention there is provided a dental implant including a first portion with a screw thread for inserting into bone, wherein the screw thread includes a first surface of a bottom of the thread facing toward an outside apical end of the dental implant, and a second surface of a top of the thread facing toward an inside top of the dental implant.

According to an aspect of some embodiments of the present invention there is provided a dental drill including a drill shank, a twist drill body, a tip, and a hole cutter, wherein a diameter of the hole cutter is larger than a diameter of a dental implant screw.

According to some embodiments of the invention, the hole cutter includes a serrated edge.

According to some embodiments of the invention, the twist drill body includes a cutting edge.

According to some embodiments of the invention, the tip includes a pilot drill. According to some embodiments of the invention, the tip includes a self-feeding screw.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings and images. With specific reference now to the drawings and the images in detail, it is stressed that the particulars shown are by way of example and for purposes of illustrative discussion of embodiments of the invention. In this regard, the description taken with the drawings and images makes apparent to those skilled in the art how embodiments of the invention may be practiced.

In the drawings:

FIG. 1 is a simplified illustration of a prior art dental implant embedded in bone, and gum tissue grown and healed around the dental implant, abutment and crown;

FIG. 2A is a simplified illustration of a dental implant according to an example embodiment of the invention;

FIGS. 2B and 2C are simplified illustrations of a dental implant according to an example embodiment of the invention;

FIG. 2D is a simplified cross-sections side view illustration of a dental implant according to an example embodiment of the invention;

FIGS. 2E and 2F are an image and a drawing, respectively, of a dental implant according to an example embodiment of the invention;

FIG. 3A is a simplified illustration of a prior art dental implant embedded in bone, and gum tissue grown and healed around the dental implant and an abutment or crown;

FIG. 3B is a simplified illustration of a dental implant according to an example embodiment of the invention;

FIG. 3C is a simplified line drawing illustration of a cross section of a dental implant according to an example embodiment of the invention;

FIG. 3D is a simplified line drawing illustration of a cross section of a dental implant according to an example embodiment of the invention;

FIGS. 3E and 3F are isometric illustrations of a dental implant according to an example embodiment of the invention;

FIG. 4 is a simplified flow chart illustration of a method of implanting a dental implant according to an example embodiment of the invention;

FIG. 5A is a simplified illustration of a dental implant according to an example embodiment of the invention;

FIG. 5B is a simplified illustration of a dental implant according to an example embodiment of the invention;

FIG. 6 is a simplified illustration of a dental implant according to an example embodiment of the invention;

FIG. 7 is a simplified flow chart illustration of a method of implanting a dental implant according to an example embodiment of the invention;

FIG. 8 is a simplified flow chart illustration of a method of manufacturing a dental implant according to an example embodiment of the invention;

FIG. 9A is a simplified drawing of a dental implant according to an example embodiment of the invention;

FIGS. 9B and 9C are simplified drawings of a single dental implant screw thread of the example embodiment of FIG. 9A;

FIGS. 10A-10D are simplified illustrations of a drill for use in a dental implant procedure according to an example embodiment of the invention; and

FIGS. 11A-11C are photographs of a result of using the drill of FIGS. 10A-10D in a dental implant procedure according to an example embodiment of the invention.

### DESCRIPTION OF SPECIFIC EMBODIMENTS OF THE INVENTION

The present invention, in some embodiments thereof, relates to a dental implant and methods of implantation, and, more particularly, but not exclusively, to an improved dental implant and improved methods of implantation.

An aspect of some embodiments includes producing or providing a dental implant with an improved shape, profile or cross section at a vicinity of the gum tissue-to-bone interface.

The term gum tissue, in the present application and claims, is used to refer to soft tissue next to a dental implant.

In the present specification and claims the term dental implant in all its grammatical forms is defined as referring to a single component for insertion into bone, not including components typically attached to a dental implant, such as a dental crown or an abutment. In some embodiments the abutment may be built into the dental implant as part of the dental implant, but when the abutment is a separate component attached to a dental implant the abutment is not included in the term dental implant.

In some embodiments, the dental implant includes a stricture, or narrowing, of a diameter of the dental implant at a level designed for the gum tissue-to-bone interface, potentially enabling the gum tissue to grow along a bone and over a bone-to-implant interface into the stricture in the dental implant.

In the present specification and claims the term stricture in all its grammatical forms is defined as referring to a narrowing of a diameter of the dental implant bounded on an apical side and an upper side by wider diameter sections of the dental implant.

In the present specification and claims the dental implant is described as having a bottom, or apical, end, and a top end.

In some embodiments, the dental implant includes a stricture of a diameter of the dental implant at a level designed for the gum tissue-to-bone interface, potentially enabling the bone to grow into the stricture in the dental implant, as well as the gum tissue to grow into the stricture.

In the human body, gum tissue serves to protect against invasion from bacteria and is part of the tissues that provide sustenance to the bone.

The term biological width, in all its grammatical forms is used throughout the present specification and claims to mean a sufficient thickness of soft tissue such as gum tissue to provide at least a minimal amount of sustenance to bone in which a dental implant is implanted. The minimal amount of sustenance is such that the bone does not get atrophied by lack of sustenance.

The term biologic width is used herein as approximately 2 mm, or in a range of 0.2 mm to 4.5 mm. The biologic width is essential for preservation of periodontal health and removal of irritation that might damage the periodontium (prosthetic restorations, for example). The width that is needed from a bottom of the junctional epithelium to a tip of the alveolar bone is held responsible for a lack of inflammation and bone resorption, and as such the development of periodontitis. The dimension of biologic width is not constant, it depends on the location of the tooth in the alveolus, varies from tooth to tooth, and also depends on an aspect of the tooth.

An aspect of some embodiments includes a dental implant having a surface of a portion of the dental implant designed to be below-bone having a different texture than a surface of a portion of the dental implant designed to be above-bone.

In some embodiments a surface of a portion of the dental implant designed to be below-bone is rougher than a surface of a portion of the dental implant designed to be above-bone.

In some embodiments a surface of a portion of the dental implant which is designed to be above bone level is optionally made to be relatively smooth, at a smoothness in a range between N ISO Grade Number N2 to electro-polished smoothness and/or to mirror finish. In some embodiments the height above bone level is of in a range between 0.5 millimeters and 6 millimeters. In some embodiments a height of the polished portion corresponds to a thickness of gum tissue at a location of the dental implant.

In some embodiments the portion of the dental implant designed to be below-bone is treated to improve bone-to-implant adherence.

In some embodiments the surface of the portion of the dental implant designed to be below-bone is treated to be rougher than the surface of the portion of the dental implant designed to be above-bone.

In some embodiments the dental implant is manufactured as a smooth component, at roughness N ISO Grade Numbers of N3, N2, N1, electro-polished and/or polished to a mirror finish.

In some embodiments a surface of an apical portion of the dental implant is roughened, optionally by blasting with particles, while a top-side portion of the dental implant is optionally prevented from roughening, optionally by covering and/or protecting from the blasting. In some embodiments a surface of an apical portion of the dental implant is roughened, optionally by exposing to one or more chemical treatments while a top-side portion of the dental implant is optionally prevented from roughening, optionally by covering and/or protecting from the chemical treatment.

In some embodiments, the surface of the portion of the dental implant designed to be below-bone is left rough during manufacturing of the dental implant.

In some embodiments the surface of the portion of the dental implant designed to be below-bone is made hydrophilic.

In some embodiments the surface of the portion of the dental implant designed to be above-bone is smoother than a surface of the portion of the dental implant designed to be below-bone.

In some embodiments the surface of the portion of the dental implant designed to be above-bone is treated to be smoother than a surface of the portion of the dental implant designed to be below-bone. In some embodiments the surface of the portion of the dental implant designed to be above-bone is treated to be smooth, at roughness N ISO Grade Numbers of N3, N2, N1, electro-polished and/or polished to a mirror finish.

In some embodiments, the surface of a portion of the dental implant designed to be above-bone is polished during manufacturing of the dental implant.

In some embodiments the portion of the dental implant designed to be above-bone is made hydrophobic.

In some embodiments the surface of the portion of the dental implant designed to be above-bone is treated to reduce adherence of the gum tissue to the dental implant.

The term “above-bone portion of the dental implant” in all its grammatical forms is used in the present specification and claims to mean a portion of the dental implant designed to be above bone when the dental implant is implanted in bone.

The term “below-bone portion of the dental implant” in all its grammatical forms is used in the present specification and claims to mean a portion of the dental implant designed to be below, or implanted within, bone when the dental implant is implanted.

An aspect of some embodiments includes a method of implanting a dental implant with an improved profile. In some embodiments the implanting is to a specific depth based on the improved shape.

An aspect of some embodiments includes an improved shape or profile or shape of cross section of threads of at least a portion of a dental implant screw.

In some embodiments the cross sectional shape of a screw thread is made to point backward relative to a direction of implantation, that relative to a direction of screw advancement.

An aspect of some embodiments includes a drill designed to produce a hole in bone and remove gum tissue simultaneously.

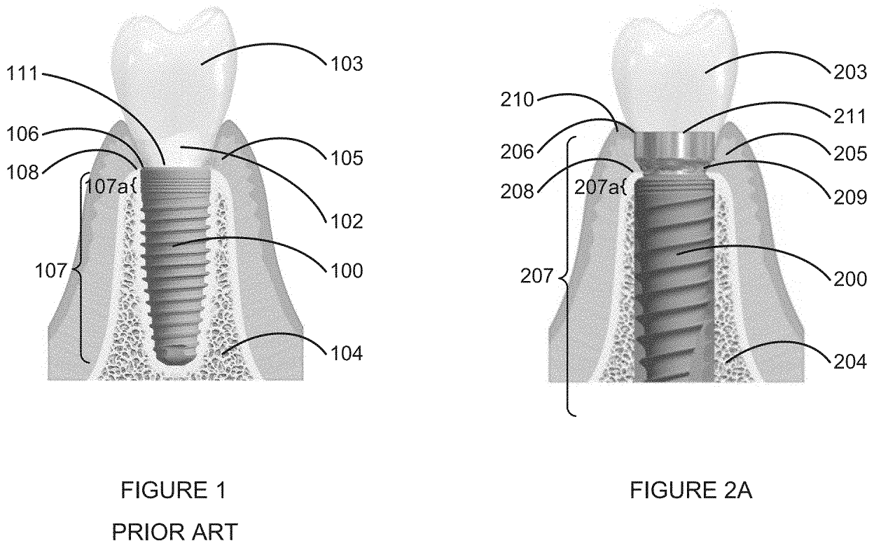

For purposes of better understanding some embodiments of the present invention, reference is first made to FIG. 1, which is a simplified illustration of a prior art dental implant 100 embedded in bone 104, and gum tissue 105 grown and healed around the dental implant 100, abutment 102 and crown 103.

FIG. 1 shows a prior art dental implant 100, with an abutment 102 attached to a top 106 of the implant 100, and a crown 103 attached to the abutment 102. The top 106 of the implant 100 is approximately level with a top 108 of a bone 104 in which the dental implant 100 is implanted. An entire length 107 of the implant 100 is typically within the bone 104, the abutment 102 connects to the top 106 of the dental implant 100 approximately at bone level, and juts above the bone 104, and the crown 103 is attached to the abutment 102.

A seam 111 formed by attaching the dental implant 100 to the abutment 102 is approximately at a level of the top 108 of the bone 104, deep beneath the gum tissue 105.

In some prior art embodiments the dental implant 100 includes a section of microgrooves 107a at a top 106 of the implant 100.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

Before explaining at least one embodiment of the invention in detail, it is to be understood that the invention is not necessarily limited in its application to the details set forth in the following description. The invention is capable of other embodiments or of being practiced or carried out in various ways.

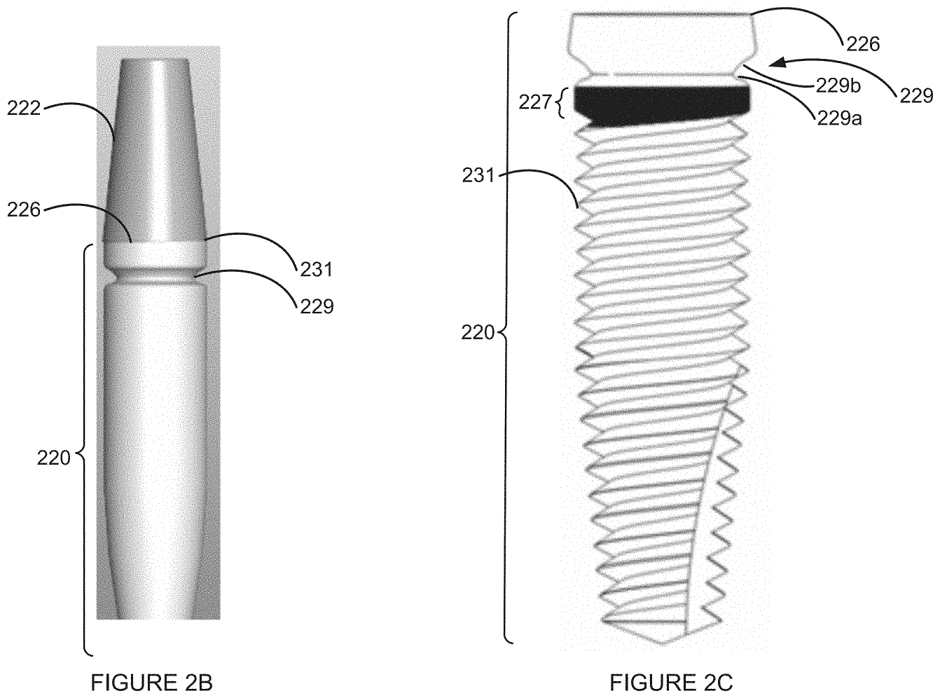

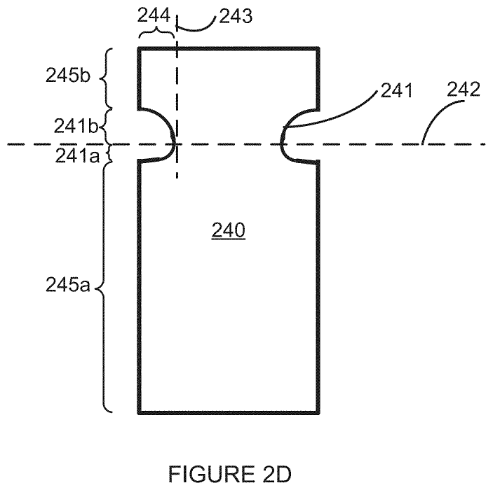

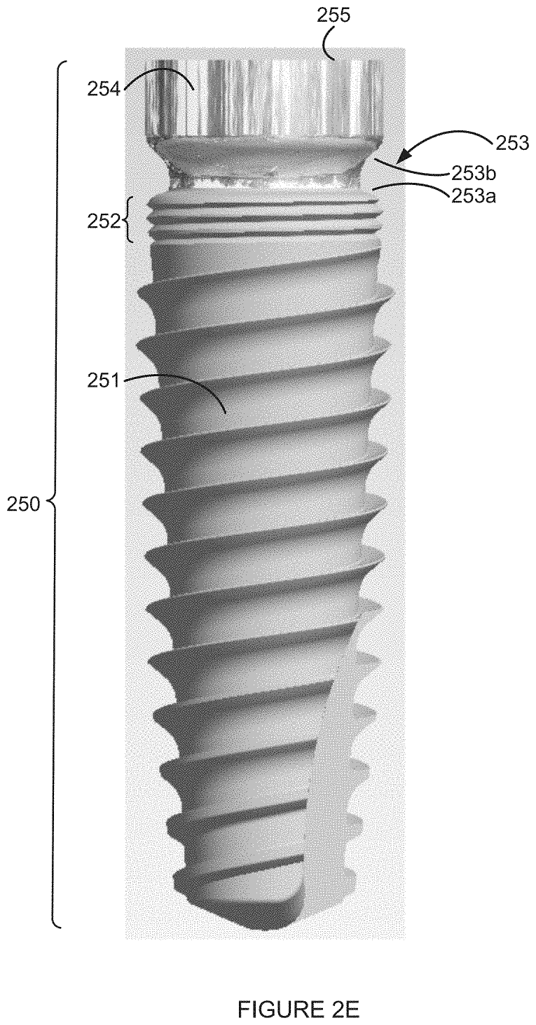

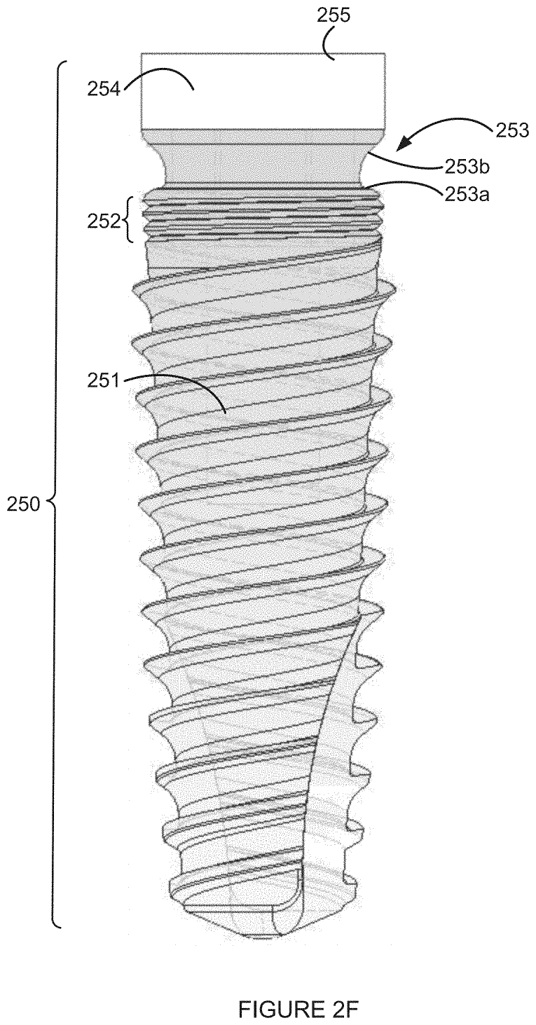

Reference is now made to FIG. 2A, which is a simplified illustration of a dental implant according to an example embodiment of the invention.

FIG. 2A shows a dental implant 200, constructed according to an example embodiment of the invention and a crown 203 attached to a top 206 of the implant 200.

FIG. 2A shows a stricture 209, or notch, in the implant 200, approximately at a level of a top 208 of the bone 204.

A portion of an entire length 207 of the implant 200 is within the bone 204, and the crown 203 connects to the top 206 of the dental implant 200 approximately at a level of a typical tooth-gum tissue interface of a healthy tooth and healthy gum tissues.

In some embodiments the dental implant 200 includes a section of micro-grooves 207a below the stricture 209.

A seam 211 formed at an attachment of the dental implant 200 to any additional structure, such as, by way of some non-limiting examples, to an abutment or to a crown 203 structure above is not at bone level, where such a seam might potentially be a location of accumulation of debris or bacteria, but at a level near a top 210 of the gum tissues.

The dental implant 200 of FIG. 2A differs from a prior art dental implant by at least the following features:

1) The dental implant 200 has a stricture 209 near a top side of the implant 200. A shape of the stricture 209 is designed to potentially provide biological width to the bone at the bone-to-implant interface. In some embodiments the bone grows into the stricture 209, and the shape of the stricture 209 is designed to potentially provide biological width to the bone growing into the stricture 209. The stricture 209 and its relation to the bone 204 and gum tissue 205 will be described in more detail further below. It is noted that the size and shape of the microgrooves in the microgroove sections 107a 207a are too small to potentially provide biological width as described above.

2) A seam 211 formed at an attachment of the dental implant 200 to an abutment or to a crown 203 structure above is at a level near a top 210 of the gum tissues and not approximately at a level of a top 208 of the bone 204.

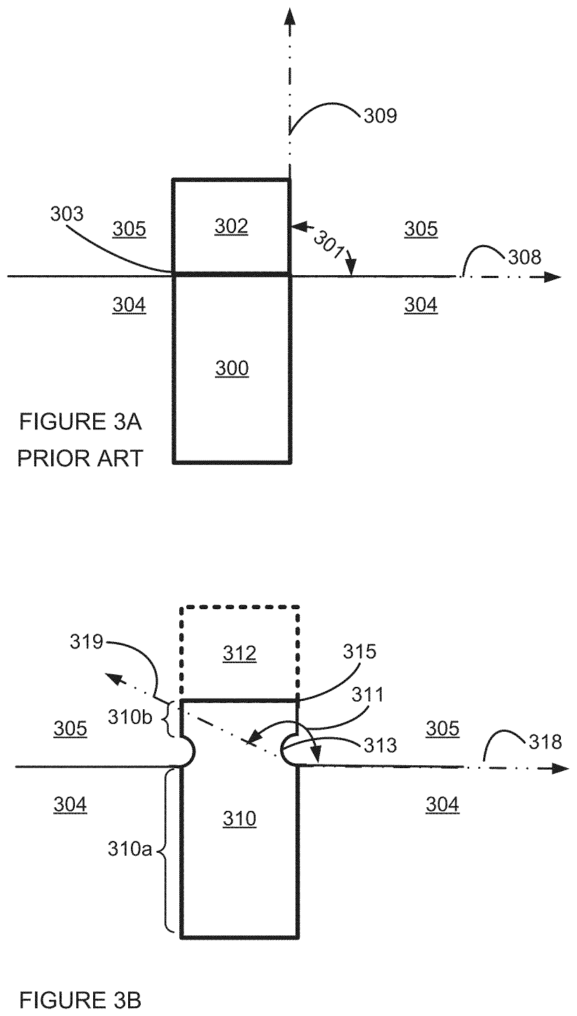

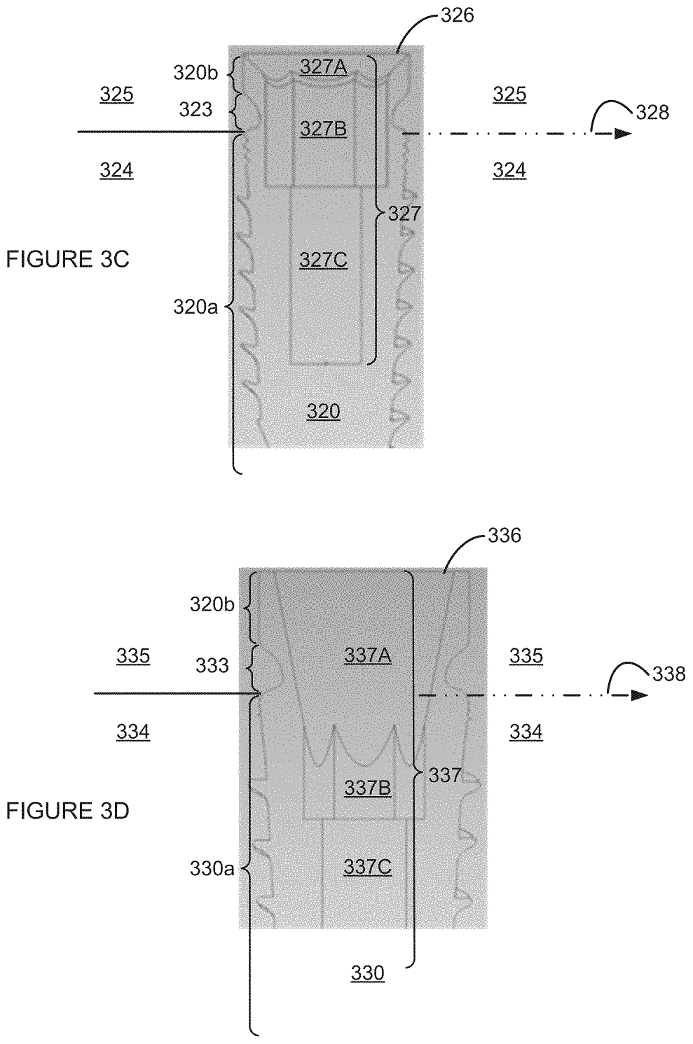

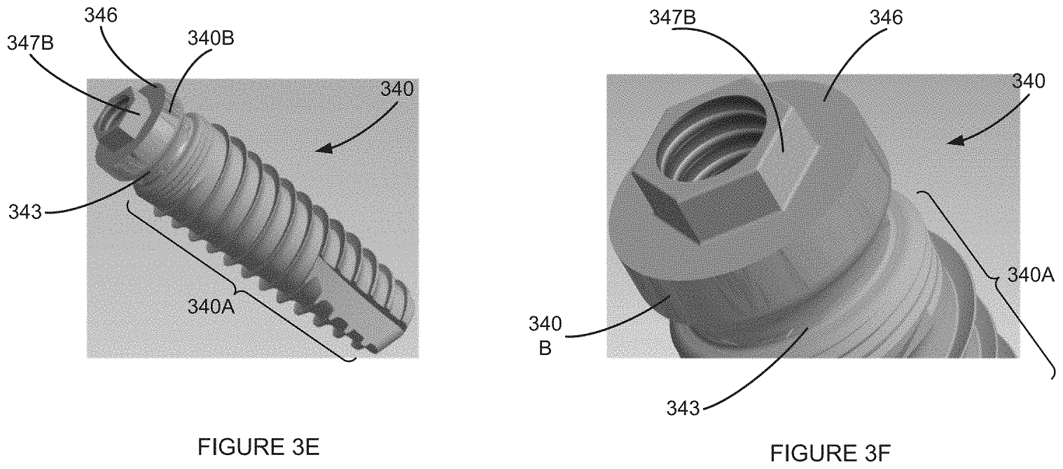

In some embodiments, the dental implant 200 is implanted into bone to a depth such that a bottom of the stricture 209 is at least approximately level with a top 208 of the bone 204. In some embodiments, after implantation, the bone 205 grows into the stricture 209, and the gum tissue 205 grows into the stricture 209. Optionally, the bone 205 grows into the stricture 209 as far as the gum tissue can provide sustenance, and optionally no more than that distance. The effect is described again with reference to FIG. 3B, in reference to a solid angle which the gum tissue forms above the bone, providing sustenance to the bone.

Reference is now made to FIGS. 2B and 2C, which are simplified illustrations of a dental implant 230 according to an example embodiment of the invention.

FIG. 2B is a simplified illustration of a dental implant 220 attached to an optional abutment 222. FIG. 2B also shows a stricture 229 in the implant 220 and a seam 231 between a top 226 of the implant 220 and the abutment 222.

In some embodiments a distance between a bottom of the stricture 229 and a top of the implant 220 corresponds to a thickness of the gum tissue.

In some embodiments a width of the stricture 229 plus a width of the top of the implant 220, above the stricture 229, corresponds to a thickness of the gum tissue.

In some embodiments just a width of the top of the implant 220, above the stricture 229, corresponds to a thickness of the gum tissue.

FIG. 2C shows a cross sectional view of the dental implant 220, the stricture 209, and the top 226 of the dental implant 220.

FIG. 2C also shows threads 231 in the dental implant 220.

FIG. 2C also shows an optional microgroove portion 227.

In some embodiments, such as shown in FIG. 2A, bone optionally grows over at least a portion of a first, apical side surface 229a of the stricture 229 and into the stricture 229. In some embodiments, even when the bone optionally grows over at least a portion of the apical side surface 229a of the stricture 229, a biological width remains above the bone and within the stricture 229.

In some embodiments, the first, apical side surface 229a of the stricture 229 is at a different angle than a second, top-side surface 229b of the stricture 229 relative to a direction of a longitudinal axis of the dental implant.

In some embodiments, by way of a non-limiting example such as shown in FIG. 2C, the top 226 of the dental implant is optionally narrower than the threads 231. In some embodiments the top 226 is manufactured with a diameter corresponding to a diameter of a standard post, while the threads 231 are optionally manufactured with a greater diameter than the standard post.

Reference is now made to FIG. 2D, which is a simplified cross-sections side view illustration of a dental implant 240 according to an example embodiment of the invention.

FIG. 2D shows a stricture 241 in the implant 240, and defines some interesting portion of the dental implant 240.

FIG. 2D shows, by way of a non-limiting example, the stricture 241 having two asymmetric or unequal portions: a bottom portion 241a and a top portion 241b.

FIG. 2D shows a line 242 marking where the bottom portion 241a ends and the top portion 241b begins.

In some embodiments a width of the stricture 241 is optionally a biological width, as defined above. In some embodiments a width of the stricture 241 is optionally greater than a biological width.

In some embodiments a width of the stricture 241 is optionally in a range of 0.3 to 2 millimeters.

In some embodiments a shape of the stricture 241 is symmetric, and a width of the bottom portion 241a of the stricture 241 is equal to a width of the top portion 241b of the stricture 241.

In some embodiments a shape of the stricture 241 is asymmetric. In some embodiments a width of the bottom portion 241a of the stricture 241 is less than a width of the top portion 241b of the stricture 241.

In some embodiments a width of the top portion 241b of the stricture 241 is optionally a biological width, as defined above. In some embodiments a width of the top portion 241b of the stricture 241 is optionally greater than a biological width.

In some embodiments a width of the top portion 241b of the stricture 241 is optionally in a range of 0.5 to 1.5 to 2 millimeters.

FIG. 2D shows a line 243 marking a depth 244 which the stricture 241 penetrates into the dental implant 240.

In some embodiments the depth 244 which the stricture 241 penetrates into the dental implant 240, is optionally in a range of 0.2 to 0.5 to 0.8 to 1.0 and even up to 1.5 millimeters.

In some embodiments a bottom portion 245a of the dental implant 240 has a different surface texture than a top portion 245b of the dental implant 240.

In some embodiments a texture of the bottom portion 245a extends also into at least part of the stricture 241. In some embodiments the texture of the bottom portion 245a extends as far as the line 242. In some embodiments the texture of the bottom portion 245a extends into the stricture 241 even further than the line 242, optionally up to a top of the stricture 241.

In some embodiments the dental implant 240 is implanted into bone at such a depth that a top of the bottom portion 245a of the dental implant 240 is below bone level, by a value in a range of 0 to 0.5 millimeters.

In some embodiments the dental implant 240 is implanted into bone at such a depth that a top of the bottom portion 245a of the dental implant 240 is at bone level.

In some embodiments the dental implant 240 is implanted into bone at such a depth that a top of the bottom portion 245a of the dental implant 240 is above bone level, by a value in a range of 0 to 0.3 to 0.6 and even to 1 millimeter.

Reference is now made to FIGS. 2E and 2F, which are an image and a drawing, respectively, of a dental implant according to an example embodiment of the invention.

FIGS. 2E and 2F show a dental implant 250, including screw threads 251, an optional microgroove portion 252, a stricture 253, and a top portion 254.

In some embodiments a distance between a bottom of the stricture 253 and a top 255 of the top portion 254 of the dental implant 250 corresponds to a thickness of the gum tissue.

In some embodiments a width of the stricture 253 plus a width of the top portion 254 of the implant 250, above the stricture 253, corresponds to a thickness of the gum tissue.

In some embodiments just a width of the top portion 254 of the implant 250, above the stricture 253, corresponds to a thickness of the gum tissue.

In some embodiments, such as shown in FIG. 2A, bone optionally grows over at least a portion of a first, apical side surface 253a of the stricture 253 and into the stricture 253. In some embodiments, even when the bone optionally grows over at least a portion of the apical side surface 253a of the stricture 253, a biological width remains above the bone and within the stricture 253.

In some embodiments, the first, apical side surface 253a of the stricture 253 is at a different angle than a second, top-side surface 253b of the stricture 253 relative to a direction of a longitudinal axis of the dental implant.

Reference is now made to FIG. 3A, which is a simplified illustration of a prior art dental implant 300 embedded in bone 304, and gum tissue 305 grown and healed around the dental implant 300 and an abutment 302 or crown 302.

FIG. 3A shows two lines 308 309 used for understanding a physiological condition existing in a case of a prior art dental implant 300 embedded in the bone 304.

A first line 308 shows a line at a level of a bone 304 to gum tissue 305 interface. The first line 308 is approximately at a level where the prior art dental implant 300 attaches to the abutment 302, and approximately at a level of a seam 303 between the prior art dental implant 300 and the abutment 302.

A second line 309 bounds an angle 301 between the first line 308 and the second line 309. The angle 301 for a prior art implant 300 and implanting method is typically approximately 90 degrees.

At locations far away from the implant 300, the bone surface 308 benefits from an interface with the gum tissue 305 spanning an entire side, a solid angle of approximately 2π steradians. Next to the implant 300 the bone surface 308 benefits from only approximately half the solid angle, approximately π steradians. It is thought that the bone surface 308 receives sustenance from the gum tissue 305, and reducing the solid angle the bone surface 308 sees at a location next to the implant 300 may cause a reduction of the bone 304 next to the implant 300.

Reference is now made to FIG. 3B, which is a simplified illustration of a dental implant 310 according to an example embodiment of the invention.

FIG. 3B shows a dental implant 310 with a stricture 313, the stricture being narrow relative to a diameter of the in-bone portion of the dental implant 310.

In some embodiments the dental implant 310 is optionally inserted into bone 304 to a depth such that the stricture 313 starts right at the bone 304 to gum tissue 305 interface, as is shown in FIG. 3B.

In some embodiments the dental implant 310 is optionally inserted into bone 304 to a depth such that the stricture 313 starts below the bone 304 to gum tissue 305 interface, as is shown in FIG. 3B. In some embodiments, even though a bottom of the stricture 313 is below the bone 304 to gum tissue 305 interface, a distance from the bone 304 to gum tissue 305 interface to a top of the stricture 313 is sufficient to potentially provide biological width. In some embodiments a width of the stricture 313 is at least equal to a biological width.

FIG. 3B shows two lines 318 319 used for understanding a physiological condition existing in a case of a dental implant 310 according to an example embodiment of the invention, embedded in bone 304.

A first line 318 shows a line at a level of the bone 304 to gum tissue 305 interface. The first line 318 is optionally significantly below a level of a seam 315 between the dental implant 310 and the abutment 312.

A second line 319 is a tangent line to a surface of the dental implant 310, where the stricture 313 begins. The second line 319 bounds an angle 311 between the first line 318 and the second line 319. The angle 311 for the implant 310 according to an example embodiment of the invention, and an implanting method according to an example embodiment of the invention, is significantly greater than 90 degrees, for example 100, 110, 120, 130, 140, 145, 150, 160, 170 and up to nearly 180 degrees.

Next to the implant 310 the bone surface 308 benefits from a greater solid angle than in the case of FIG. 3A, greater than π steradians, and up to approximately 2π steradians. Increasing the solid angle the bone surface 308 benefits from, at a location next to the implant 310, can potentially significantly improve physiological health of the bone 304 next to the implant 310.

FIG. 3B shows an example embodiment where the dental implant 310 is optionally inserted into the bone 304 to a depth such that the stricture 313 starts approximately at the bone 304 to gum tissue 305 interface.

In some embodiments a width of a top-side, above the stricture 313, portion 310b of the dental implant 310 is nowhere wider than a diameter of a top of an apical-side, below the stricture 313, portion 310a of the dental implant 310. In such embodiments the top-side portion 310b does not obstruct the gum tissue 305 from the bone 304.

In some embodiments a width of the top-side, above the stricture 313, portion 310b of the dental implant 310 is nowhere wider than a diameter of the dental implant 310 at a top of a section of screw threads (not shown in FIG. 3B, but shown, by way of some non-limiting examples, in FIGS. 2A and 2C) in the apical-side, below the stricture 313, portion 310a of the dental implant 310.

In some embodiments a width of the portion 310b plus a width of the stricture 313 are at least a biological width above a bottom of the stricture 313.

In some embodiments the dental implant 310 is optionally implanted to such a depth that a bottom of the stricture 313 is at bone level, or approximately at bone 304 level, and the width of the portion 310b plus a width of the stricture 313 being at least a biological width above a bottom of the stricture 313 enable gum tissue to grow and provide biological width above the bottom of the stricture 313 level, or above the bone 304 level.

In some embodiments a width of the portion 310b is at least a biological width above a top of the stricture 313.

In some embodiments the dental implant 310 is optionally implanted to such a depth that a bottom of the stricture is below bone 304 level, or approximately below bone 304 level, and the width of the portion 310b being at least a biological width above a top of the stricture 313 enables gum tissue to grow and provide biological width above the stricture 313, and potentially allowing bone 304 to grow into the stricture 313.

In some embodiments, after implantation, the bone 304 grows into the stricture 313, and the gum tissue 305 grows into the stricture 313. Optionally, the bone 304 grows into the stricture 313 as far as the gum tissue 305 can provide sustenance to the bone 304, and optionally no more than that distance.

In some embodiments an angle, equivalent to the angle 311, which the bone 304 forms with a side of the stricture 313, after growth, is significantly greater than 90 degrees, for example 100, 110, 120, 130, 140, 145, 150, 160, 170 and up to nearly 180 degrees.

In some embodiments a top surface of the dental implant 310, at the seam 315, is at a distance of at least a thickness of a prospective patient's gum above a bottom of the stricture 313.

In some embodiments the top surface of the dental implant 310, at the seam 315, is at a distance of at least a thickness of a prospective patient's gum above a top of the stricture 313.

In some embodiments the top surface of the dental implant 310, at the seam 315, is designed to be supra gingival, above the gingiva. Such a dental implant potentially enables an operator to perform a one-stage implant operation, as opposed to a two-stage implant operation. In a two-stage implant operation, stage one includes implant insertion and covering the implant with gum, and stage two includes exposure of the implant and connection of an abutment, or taking an impression for a dental prosthesis. A one-stage operation is potentially enabled by virtue of the implant including a top which is above a surface of the gum, or at least close to the surface of the gum, so that an implant exposure operation stage is not needed, or becomes a small uncovering of the implant.

In some embodiments a top surface of the dental implant 310, at the seam 315, is at a distance providing biological width above a bottom of the stricture 313.

In some embodiments the top surface of the dental implant 310, at the seam 315, is at a distance providing biological width above a top of the stricture 313.

In some embodiments the top surface of the dental implant 310, at the seam 315, is designed to be above the bone 304 and below a surface of the gum tissue 305.

Reference is now made to FIG. 3C, which is a simplified line drawing illustration of a cross section of a dental implant according to an example embodiment of the invention.

FIG. 3C shows a dental implant 320 with a stricture 323, a bottom, in-bone portion 320a of the dental implant 320, and a top portion 320b of the dental implant 320.

FIG. 3C, being an illustration of a cross section of the dental implant 320, also shows a hollow 327 within the dental implant 320 which includes:

an interface portion 327A for interfacing with an abutment (not shown) or a dental prosthesis (not shown);

a polygonal-shaped portion 327B for inserting a rotation tool in order to screw the dental implant 320 into bone 324; and

a hole 327C for inserting a screw and securing the abutment or the dental prosthesis.

The hollow 327 optionally conforms to a standard dental-implant rotation tool and/or to a dental-implant to dental prosthesis connector.

In some embodiments the dental implant 320 is optionally inserted into bone 324 to a depth such that the stricture 323 starts right at the bone 324 to gum tissue 325 interface, as is shown in FIG. 3C.

In some embodiments the dental implant 320 is optionally inserted into bone 324 to a depth such that the stricture 323 starts below the bone 324 to gum tissue 325 interface, as is shown in FIG. 3C. In some embodiments, even though a bottom of the stricture 323 is below the bone 324 to gum tissue 325 interface, a distance from the bone 324 to gum tissue 325 interface to a top of the stricture 323 is sufficient to potentially provide biological width. In some embodiments a width of the stricture 323 is at least equal to a biological width. In some embodiments a width of the stricture 323 plus a width 320b of a portion of the dental stricture 320 above the stricture 323 is at least equal to a biological width.

FIG. 3C shows a first line 328 shows at a level of the bone 324 to gum tissue 325 interface. The first line 328 is optionally significantly below a level of a seam between a top 326 of the dental implant 320 and an abutment (not shown).

In some embodiments a difference in height between the top 326 of the dental implant 320 and the line 328 is at least a biological width.

In some embodiments a difference in height between the top 326 of the dental implant 320 and the line 328 is at least a thickness of gum tissue.

FIG. 3C shows an example embodiment where the dental implant 320 is optionally inserted into the bone 324 to a depth such that the stricture 323 starts approximately at the bone 324 to gum tissue 325 interface.

In some embodiments a width of the portion 320b plus a width of the stricture 323 are at least a biological width above a bottom of the stricture 323.

Reference is now additionally made to FIG. 3D, which is a simplified line drawing illustration of a cross section of a dental implant according to an example embodiment of the invention.

FIG. 3D shows a dental implant 330 with a stricture 333, a bottom, in-bone portion 330a of the dental implant 330, and a top portion 330b of the dental implant 330.

FIG. 3D, being an illustration of a cross section of the dental implant 330, also shows a hollow 337 within the dental implant 330 which includes:

an conical interface portion 337A for interfacing with an abutment (not shown) or a dental prosthesis (not shown);

a polygonal-shaped portion 337B for inserting a rotation tool in order to screw the dental implant 330 into bone 334; and

a hole 337C for inserting a screw and securing the abutment or the dental prosthesis. In some embodiments an angle of the cone of the conical interface portion 337A is 11 degrees from a parallel to a longitudinal axis of the dental implant 330.

In some embodiments the hollow 337 optionally conforms to a conical dental-implant rotation tool and/or to a conical dental-implant to dental prosthesis connector.

It is noted that in some embodiments, a thickness, or width, of a wall of the dental implant 320 between the internal polygonal hollow 327B and the stricture 323 of FIG. 3C may be a thinnest section of a wall of the dental implant 320.

It is noted that in some embodiments, a thickness, or width, of a wall of the dental implant 330 between the conical interface 337A and the stricture 323 of FIG. 3D may be a thinnest section of a wall of the dental implant 330.

In some embodiments, a polygonal portion for rotating and screwing the dental implant into bone is manufactured on top of the dental implant. Such a polygonal portion is sometimes referred to as an external hex or external polygon.

Reference is now made to FIGS. 3E and 3F, which are isometric illustrations of a dental implant according to an example embodiment of the invention.

FIGS. 3E and 3F show a dental implant 340 with a stricture 343, a bottom, in-bone portion 340a of the dental implant 340, and a top portion 340b of the dental implant 340.

FIGS. 3E and 3F also show an external polygonal connector 347B on a top side 346 of the dental implant 340.

In some embodiments, building an external polygonal connector 347B potentially enables having a thicker wall between a hole 347C for attaching a dental prosthesis (not shown) or an abutment (not shown) and an outside of the dental implant 340.

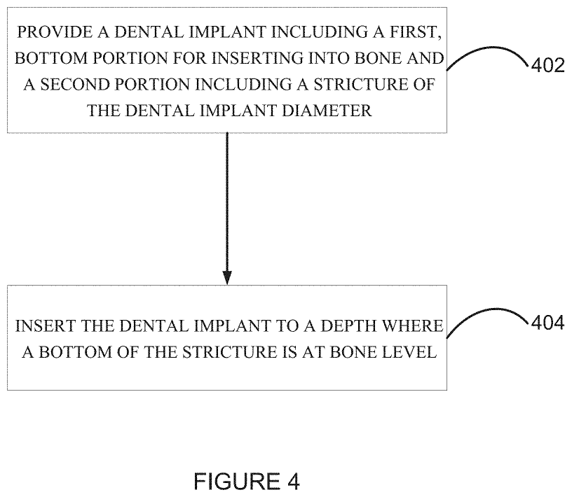

Reference is now made to FIG. 4, which is a simplified flow chart illustration of a method of implanting a dental implant according to an example embodiment of the invention.

The method of FIG. 4 includes:

providing a dental implant including a first, apical portion for inserting into bone and a second, top-side portion including a stricture of the dental implant diameter, relative to a diameter of the first portion, for at least part of the second portion (402); and

inserting the dental implant to a depth where a bottom of the stricture is at bone level (404).

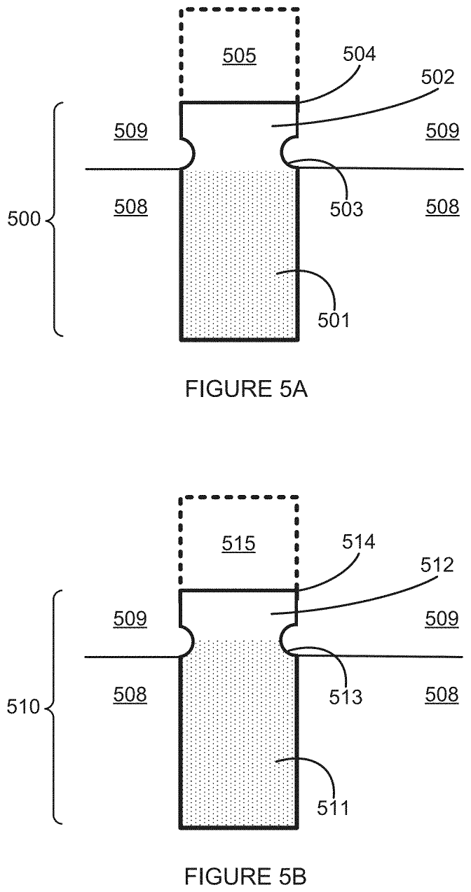

Reference is now made to FIG. 5A, which is a simplified illustration of a dental implant 500 according to an example embodiment of the invention.

FIG. 5A shows a dental implant 500 with a stricture 503, the narrow diameter being narrow relative to a diameter of the in-bone portion of the dental implant 500. FIG. 5A shows the dental implant 500 embedded in bone 508, and gum tissue 509 grown and healed around the dental implant 500 and an optional abutment 505 or crown 505

FIG. 5A shows a first, bottom portion 501 of the dental implant 500 having a different surface texture than a second portion 502.

In some embodiments the dental implant 500 is optionally inserted into the bone 508 to a depth such that the stricture 503 starts right at, just below, or just above, optionally within X millimeters of the bone 508 to gum tissue 509 interface, as is shown in FIG. 5A. In some embodiments, X is in a range between 0-3 millimeters or 0-5 millimeters.

In some embodiments the first portion 501 of the dental implant 500 is made to have a rougher texture than the second portion 502.

In some embodiments the second portion 502 of the dental implant 500 is made to have a smoother texture than the first portion 501.

In some embodiments the first portion 501 of the dental implant 500 is made to have a rough surface and the second portion 502 is made to have a smooth surface.

In some embodiments the second portion 502 is polished to a smoothness value of roughness N ISO Grade Numbers of N3, N2, N1, electro-polished and/or polished to a mirror finish.

In some embodiments the first portion 501 of the dental implant 500 is coated with a hydrophilic coating.

In some embodiments the second portion 502 of the dental implant 500 is coated with a hydrophobic coating.

In some embodiments the first, bottom portion 501 of the dental implant 500 is embedded in the bone 508 and reaches up to a beginning of the stricture 503, as shown in FIG. 5A.

In some embodiments the surface texture of the first, bottom portion 501 of the dental implant 500 reaches up to the beginning of the stricture 503, as shown in FIG. 5A.

In some embodiments the surface texture of the first, bottom portion 501 of the dental implant 500 reaches into the stricture 503. In some embodiments, the surface texture of the first, bottom portion 501 of the dental implant 500 reaches into the stricture 503 to a distance which still leaves a portion of the stricture 503 with the surface texture of the second portion 502 of the dental implant 500 wide enough to provide biological width.

Reference is now made to FIG. 5B, which is a simplified illustration of a dental implant 510 according to an example embodiment of the invention.

FIG. 5B shows the dental implant 510 embedded in bone 508, and gum tissue 509 grown and healed around the dental implant 510 and an optional abutment 515 or crown 515

FIG. 5B shows a dental implant 510 with a stricture 513, the narrow diameter being narrow relative to a diameter of the in-bone portion of the dental implant 510.

FIG. 5B shows a first, bottom portion 511 of the dental implant 510 having a different surface texture than a second portion 512.

In some embodiments the dental implant 510 is optionally inserted into the bone 508 to a depth such that the stricture 513 starts right at, just below, or just above, optionally within X millimeters of the bone 508 to gum tissue 509 interface, as is shown in FIG. 5B. In some embodiments, X is in a range between 0-3 millimeters or 0-5 millimeters.

In some embodiments the first, bottom portion 511 of the dental implant 510 is embedded in the bone 508 and the surface texture of the first portion 511 reaches a portion of a width of the stricture 503 into the stricture 503, as shown in FIG. 5B.

In some embodiments (not shown in FIG. 5B) the first, bottom portion 511 of the dental implant 510 is embedded in the bone 508 and the surface texture of the first portion 511 reaches all the way across the width of the stricture 503.

In some embodiments (not shown in FIG. 5B) the first, bottom portion 511 of the dental implant 510 is embedded in the bone 508 and the surface texture of the first portion 511 reaches all the way across the width of the stricture 503 and even higher, beyond the stricture 503.

FIGS. 5A and 5B show example embodiments where dental implants 501 511 are optionally inserted into bone 508 to a depth such that the strictures 503 513 start approximately at the bone 508 to gum tissue 509 interface.

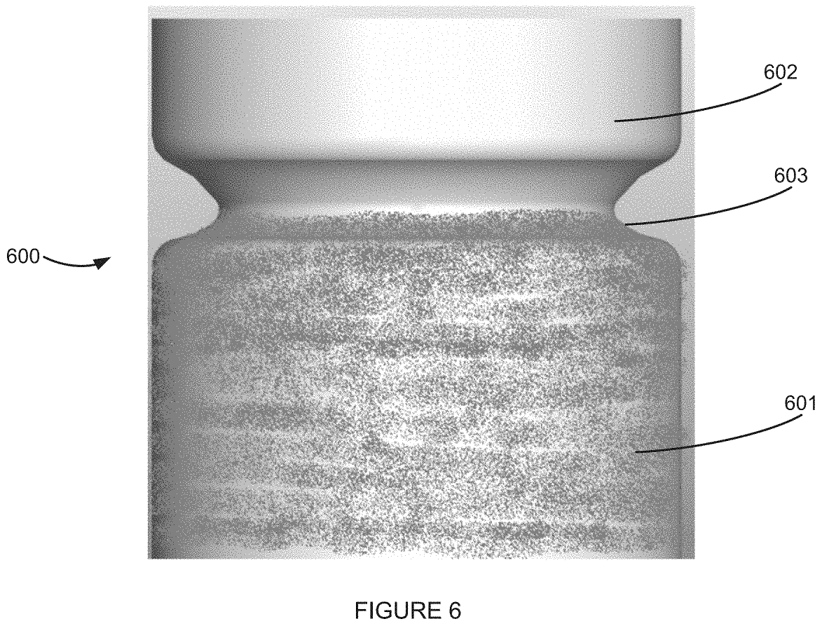

Reference is now made to FIG. 6, which is a simplified illustration of a dental implant 600 according to an example embodiment of the invention.

FIG. 6 shows a dental implant 600 with a stricture 603, the narrow diameter being narrow relative to a diameter of the in-bone portion of the dental implant 500.

FIG. 6 shows a first, bottom portion 601 of the dental implant 500 having a different surface texture than a second portion 602.

In some embodiments the first portion 601 of the dental implant 600 is made to have a rougher texture than the second portion 602. In some embodiments the second portion 602 of the dental implant 600 is made to have a smoother texture than the first portion 601. In some embodiments the first portion 601 of the dental implant 600 is made to have a rough surface and the second portion 602 is made to have a smooth surface.

In some embodiments the first portion 601 of the dental implant 600 is coated with a hydrophilic coating. In some embodiments the second portion 602 of the dental implant 600 is coated with a hydrophobic coating.

In some embodiments the surface texture of the first, bottom portion 601 of the dental implant 600 reaches up to the beginning of the stricture 603.

In some embodiments the surface texture of the first, bottom portion 601 of the dental implant 600 reaches into the stricture 603, as shown in FIG. 6.

In some embodiments the surface texture of the first, bottom portion 601 of the dental implant 600 reaches into the stricture 603, not shown in FIG. 6, the surface texture of the first portion 601 reaches all the way across the width of the stricture 603.

In some embodiments (not shown in FIG. 6) the surface texture of the first portion 601 reaches all the way across the width of the stricture 603 and even higher, beyond the stricture 603.

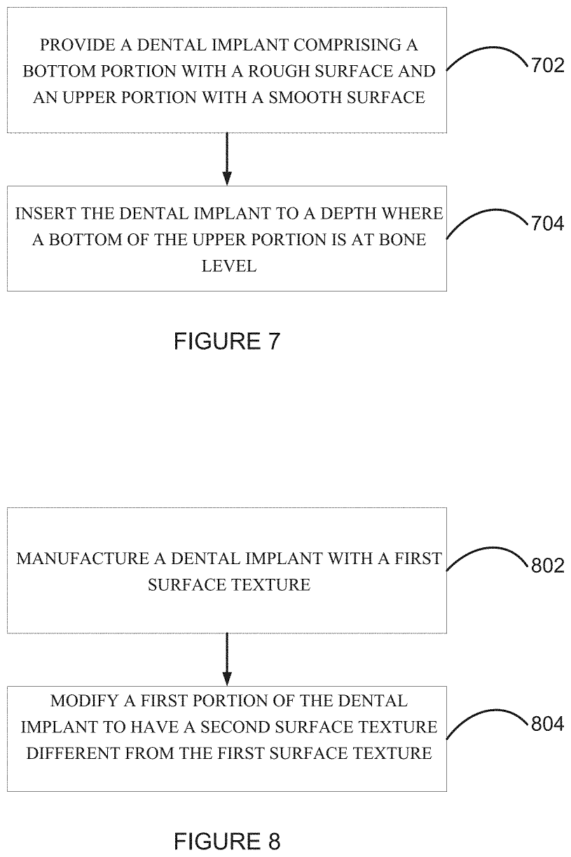

Reference is now made to FIG. 7, which is a simplified flow chart illustration of a method of implanting a dental implant according to an example embodiment of the invention.

The method of FIG. 7 includes:

providing a dental implant comprising a bottom portion with a rough surface for inserting into bone and an upper portion with a smooth surface starting at a level of bone surface and higher (702); and

inserting the dental implant to a depth where a bottom of the upper portion is at bone level (704).

FIGS. 5A, 5B and 6 show example embodiments where dental implants 501 511 600 optionally include a first, bottom portion of the dental implant having a different surface texture than a second portion.

Reference is now made to FIG. 8, which is a simplified flow chart illustration of a method of manufacturing a dental implant according to an example embodiment of the invention.

The method of FIG. 8 includes:

manufacturing a dental implant with a first surface texture (802); and

modifying a first portion of the dental implant to have a second surface texture different from the first surface texture (804).

In some embodiments, the dental implant is first manufactured, and then a surface of an upper portion of the dental implant is optionally polished in order to make the surface of the upper portion smoother than the surface of a bottom portion of the dental implant.

In some embodiments, the dental implant is first manufactured, and then a surface of a lower, apical portion of the dental implant is optionally roughened in order to make the surface of the apical portion rougher than the surface of a top portion of the dental implant.

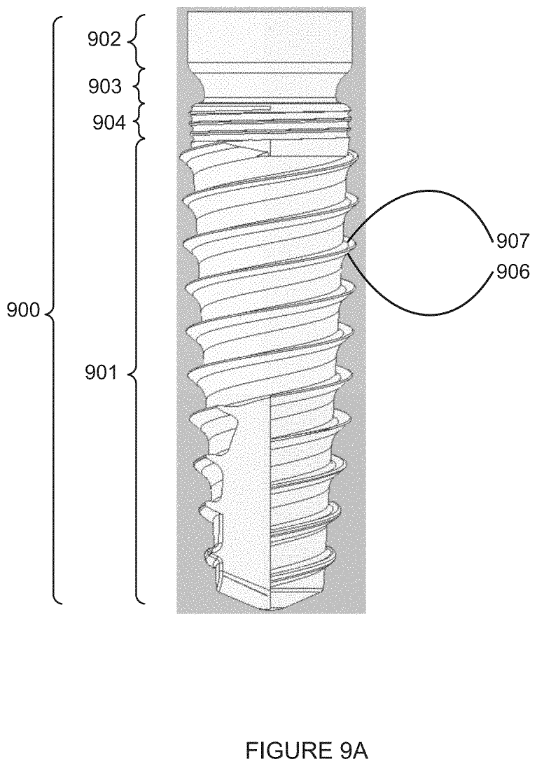

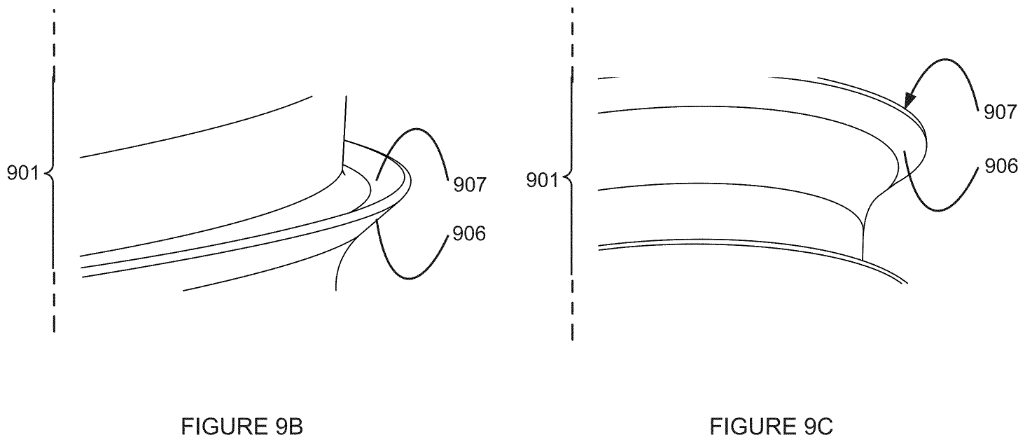

Reference is now made to FIG. 9A, which is a simplified drawing of a dental implant according to an example embodiment of the invention.

FIG. 9A is intended to show a specific screw thread design according to an example embodiment of the invention.

FIG. 9A shows a dental implant 900 including a first portion 901 with a screw thread for inserting into bone.

FIG. 9A shows the screw thread including a first surface 906 of a bottom of the thread, facing toward an outside bottom of the dental implant 900, and a second surface 907 of a top of the thread, facing toward an inside top of the dental implant.

FIG. 9A also shows additional, optional parts of the dental implant 900, such as an optional stricture 903, an optional top portion 902, and an optional microgroove portion 904.

In some embodiments the first surface 906 of the thread and the second surface 907 of the thread are not symmetrical with respect to the thread shape.

In some embodiments the second surface 907 of the top of the thread is concave.

In some embodiments, the first surface 906 of the bottom of the thread is convex.

The thread design of FIG. 9A potentially grabs bone with a concave surface of the thread, optionally the second surface 907 of the top of the thread, and pushes the implant 900 into a hole prepared in bone.

Reference is now additionally made to FIGS. 9B and 9C, which are simplified drawings of a single dental implant screw thread of the example embodiment of FIG. 9A.

FIG. 9B shows an isometric top view of a single dental implant screw thread in the first portion 901 of the dental implant 900.

FIG. 9B shows the first surface 906 of the bottom of the thread, facing toward an outside bottom of the dental implant 900, and the second surface 907 of the top of the thread, facing toward an inside top of the dental implant 900.

FIG. 9C shows an isometric bottom view of the single dental implant screw thread in the first portion 901 of the dental implant 900.

FIG. 9C shows the first surface 906 of the bottom of the thread, facing toward an outside bottom of the dental implant 900, and the second surface 907 of the top of the thread is hidden due to the bottom isometric view.

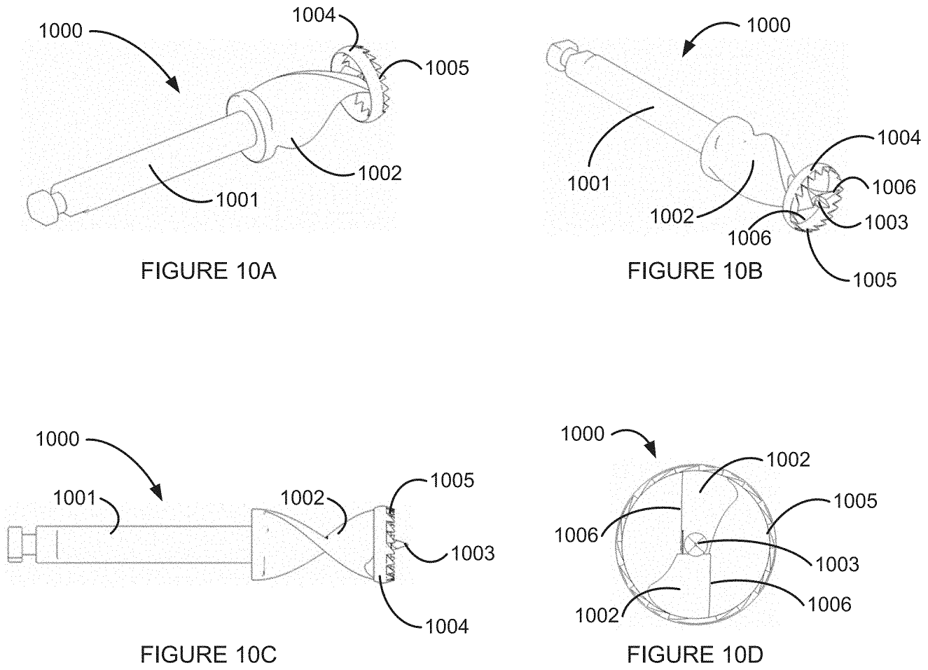

Reference is now made to FIGS. 10A-10D, which are simplified illustrations of a drill 1000 for use in a dental implant procedure according to an example embodiment of the invention.

FIGS. 10A and 10B are two isometric views of the drill 1000.

FIG. 10C is a side view of the drill 1000.

FIG. 10D is a bottom view of the drill 1000.

FIGS. 10A-10D show the drill 1000 from different directions, exposing various parts of the drill 100.

FIG. 10A-10D shows the following parts of the drill 1000:
a drill shank 1001;
a twist drill body 1002;
a tip 1003; and
a hole cutter 1004.

In some embodiments the hole cutter 1004 includes a serrated edge 1005. In some embodiments the twist drill body 1002 includes a cutting edge 1006.

In some embodiments the tip 1003 is a pilot drill 1003.

In some embodiments the tip 1003 is a self-feeding screw 1003.

In some embodiments the twist drill body 1002 is short, in order to keep a length of the entire drill 1000 short, for convenience in working in a patient's mouth.

In some embodiments the twist drill body 1002 includes a single flute (not shown) or a double flute (as in FIGS. 10A-10D) starting from the cutting edge(s) 1006, for removal of gum tissue.

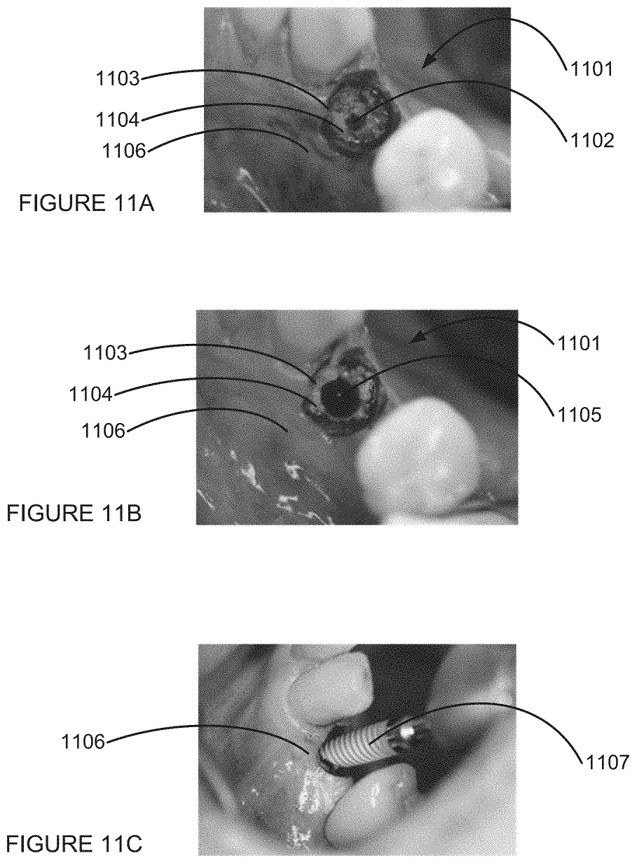

Reference is now made to FIGS. 11A-11C, which are photographs of a result of using the drill 1000 of FIGS. 10A-10D in a dental implant procedure according to an example embodiment of the invention.

FIG. 11A is a photograph of a space 1101 being prepared for a dental implant.

FIG. 11A shows a result of the drill preparing a central pilot hole 1102 in bone, the central pilot hole 1102 optionally surrounded by an area of leveled bone 1104, and by an optional circular channel 1103. FIG. 11A also shows surrounding gum tissue 1106, or gum.

In some embodiments the central pilot hole 1102 is optionally made by the tip 1003 of the drill 1000 of FIGS. 10A-10D.

In some embodiments the optional area of leveled bone 1104 is optionally made by the twist drill body 1002 of the drill 1000 of FIGS. 10A-10D.

In some embodiments the optional area of optionally leveled bone 1104 is optionally made by the cutting edge 1006 of the drill 1000 of FIGS. 10A-10D.

In some embodiments the optional circular channel 1103 is optionally made by the hole cutter 1004 of the drill 1000 of FIGS. 10A-10D.

In some embodiments the optional circular channel 1103 is optionally made by the serrated edge 1005 of the hole cutter 1004 of the drill 1000 of FIGS. 10A-10D.

FIG. 11B shows a result of an additional drill (not shown) having drilled a hole 1105 for a dental implant (not shown) in addition to the preparations shown in FIG. 11B.

FIG. 11C shows a dental implant 1107 being screwed into the hole 1105 shown in FIG. 11B.

In some embodiments a diameter of the area of leveled bone 1104 is optionally greater than a diameter of the dental implant 1107, so that the dental implant 1107 does not touch gum tissue 1106 during insertion of the dental implant 1107.

In some embodiments a diameter of the optional circular channel 1103 is optionally greater than a diameter of the dental implant 1107, so that the dental implant 1107 does not touch gum tissue 1106 during insertion of the dental implant 1107.

As used herein the term “about” refers to ±20%.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A dental implant comprising:
a first, apical portion for inserting into bone; and
a second, top-side portion, starting at a level of bone surface and higher, comprising a stricture of the dental implant diameter, relative to a diameter of the top-side portion, for at least part of the top-side portion.

2-46. (canceled)
